(19) United States
(12) Patent Application Publication
(10) Pub. No.: US 2012/0042335 A1
(43) Pub. Date: Feb. 16, 2012

(54) METHOD AND APPARATUS FOR REPRODUCING ADVERTISEMENT

(75) Inventors: In-chul HWANG, Suwon-si (KR); Mun-Jo KIM, Suwon-si (KR)

(73) Assignee: SAMSUNG ELECTRONICS CO., LTD., Suwon-si (KR)

(21) Appl. No.: 13/210,935

(22) Filed: Aug. 16, 2011

Related U.S. Application Data
(60) Provisional application No. 61/373,908, filed on Aug. 16, 2010.

(30) Foreign Application Priority Data
Jul. 12, 2011 (KR) 10-2011-0068977

(51) Int. Cl. H04N 7/10

(52) U.S. Cl. 725/32

(57) ABSTRACT

A method of reproducing an advertisement in an audio/video (AV) content receiver which receives AV contents via a broadcasting network and an IP network, the method including receiving a second file including information regarding an address of a first file which includes information required for reproducing an AV content and metadata of an advertisement content to be inserted to the AV content and reproduced with the AV content; receiving the first file based on the received second file; and inserting the advertisement content to the AV content based on the metadata of the advertisement content included in the first file and reproducing the advertisement content with the AV content.

### CROSS-REFERENCE TO RELATED PATENT APPLICATION

This application claims the benefit of U.S. Provisional Patent Application No. 61/373,908, filed on Aug. 16, 2010 in the U.S. Patent and Trademark Office, and Korean Patent Application No. 10-2011-0068977, filed on Jul. 12, 2011 in the Korean Intellectual Property Office, the disclosures of which are incorporated herein in their entireties by reference.

### BACKGROUND

1. Field

Methods and apparatuses consistent with exemplary embodiments relate to reproducing an advertisement in a receiver which receives contents via a broadcasting network and an IP network.

2. Description of the Related Art

Recently, as combination of broadcasting services and IP communications are becoming common, a technique for reproducing advertisement contents in various ways via TVs supporting both high-quality broadcasting services and data communication services, such as a smart TV, hybrid broadcast broadband TV (HBBTV), and an open hybrid TV (OHTV), is demanded.

### SUMMARY

According to an aspect of an exemplary embodiment, there is provided a method of reproducing an advertisement in an audio/video (AV) content receiver which receives AV contents via a broadcasting network and an IP network, the method including receiving a second file including information regarding an address of a first file which includes information required for reproducing an AV content and metadata of an advertisement content to be inserted to the AV content and reproduced with the AV content; receiving the first file based on the information regarding address of the first file; and inserting the advertisement content to the AV content based on the metadata of the advertisement content included in the first file and reproducing the advertisement content with the AV content.

The address of the first file may be an address for receiving the first file via the IP network or an address for receiving the first file via the broadcasting network.

The second file may be a content access descriptor (CAD) file of an AV content.

The first file may be an OHTV manifest file.

The first file may include information regarding an identifier of an advertisement content stored in the AV content receiver.

The AV content may include at least a portion divided on a time basis, and the information regarding an identifier of the advertisement content included in the first file may be included in a value of an attribute of a same level element as the element including at least a portion divided on the time basis.

The first file may include information regarding an address for reporting a result of reproducing the advertisement content.

The AV content may include at least a portion divided on a time basis, and the information regarding an address for reporting a result of reproducing the advertisement content included in the first file may be included in a value of an attribute of a same level element as the element including at least a portion divided on the time basis.

The first file may include information regarding player control level for controlling reproduction of the advertisement content.

The information regarding address of the first file included in the second file may be included in an element arranged separately from the element including information required for reproducing the AV content.

The first file may include at least one of an element including information regarding a location of an advertisement content in a server; an element including information regarding an identifier of an advertisement content stored in the AV content receiver; an element including information regarding an address for reporting a result of reproducing the advertisement content; and an element including information regarding authorization for controlling reproduction of the advertisement content.

The first file may be a media presentation description (MPD) of 3GPP/OIPF.

The AV content may be an AV content streamed via the IP network, and the advertisement content is an advertisement content stored in the AV content receiver.

The AV content may be an AV content that is downloaded via the IP network and stored in the AV content receiver.

An element TransferType of the AV content may be an element indicating that reproduction of the AV content includes reproducing a file downloaded via the IP network and stored in the AV content receiver with at least one other files.

The AV content may be an AV content received via the broadcasting network and stored in the AV content receiver.

The AV content may be an AV content received by using non real-time (NRT) method, and the second file may be a CAD file of an AV content received by using NRT method.

The first file may include information for combining and reproducing a plurality of files that are received via the broadcasting network and stored in the AV content receiver.

According to another aspect of an exemplary embodiment, there is provided a method of reproducing an advertisement in an AV content receiver which receives AV contents via a broadcasting network and an IP network, the method including an operation in which a broadcasting company application provides an identifier of an AV content and metadata of an advertisement content to be inserted to the AV content and reproduced with the AV content to an AV object; and an operation in which the AV object inserts the advertisement content to the AV content based on the identifier of the AV content and the metadata of the advertisement content and reproduces the advertisement content with the AV content.

The metadata of the advertisement content may include an address for receiving the advertisement content via the IP network or an address for receiving the advertisement content via the broadcasting network.

The metadata of the advertisement content may be an Extensible Markup Language (XML) string.

The method may further include an operation in which the broadcasting company application receives the metadata of the advertisement content from a broadcasting company server.

According to another aspect of an exemplary embodiment, there is provided an AV content receiver which receives AV contents via a broadcasting network and an IP network, the AV content receiver including a reception unit which receives a second file including information regarding an address of a first file, which includes information required for reproducing an AV content and metadata of an advertisement content to be inserted to the AV content and reproduced with the AV content, and receives the first file based on the information regarding address of the first file; and a reproduction unit which inserts the advertisement content to the AV content based on the metadata of the advertisement content included in the first file and reproduces the advertisement content with the AV content.

The first file may include information regarding an address for reporting a result of reproducing the advertisement content.

The first file may include information regarding player control level for controlling reproduction of the advertisement content.

The AV content may be an AV content streamed via the IP network, and the advertisement content may be an advertisement content stored in the AV content receiver.

The AV content may be an AV content that is downloaded via the IP network and stored in the AV content receiver.

The AV content may be an AV content received via the broadcasting network and stored in the AV content receiver.

According to another aspect of an exemplary embodiment, there is provided an AV content receiver which receives AV contents via a broadcasting network and an IP network, the AV content receiver including a broadcasting company application which provides an identifier of an AV content and metadata of an advertisement content to be inserted to the AV content and reproduced with the AV content to an AV object; and the AV object which inserts the advertisement content to the AV content based on the identifier of the AV content and the metadata of the advertisement content and reproduces the advertisement content with the AV content.

According to another aspect of an exemplary embodiment, there is provided a non-transitory computer readable recording medium having recorded thereon a computer program for implementing a method according to an embodiment.

### BRIEF DESCRIPTION OF THE DRAWINGS

The above and/or other features and advantages will become more apparent by describing in detail exemplary embodiments thereof with reference to the attached drawings in which:

FIG. 1 is a diagram showing configuration of an audio/video (AV) content receiver for receiving AV content via a broadcasting network and an IP network, according to an embodiment;

FIG. 2 is a flowchart showing a method by which the AV content receiver according to the present embodiment reproduces an advertisement;

FIG. 3 is a sequence diagram showing a method of inserting an advertisement content to a stream-based VoD content and reproducing the VoD content, according to an embodiment;

FIG. 4 is a sequence diagram showing a method of inserting an advertisement content to an NRT-based Push VoD content and reproducing the advertisement content with the Push VoD content, according to an embodiment;

FIG. 5 is a sequence diagram showing a method of inserting an advertisement content to an AV content and reproducing the advertisement content with the AV content by using a broadcasting company application;

FIG. 6 is a diagram showing an AdContents XML schema according to an embodiment;

FIG. 7 is a flowchart showing a method by which the AV content receiver according to the present embodiment inserts an advertisement content to a VoD content and reproduces the advertisement content with the VoD content;

FIG. 8 is a sequence diagram showing a method by which the AV content receiver according to the present embodiment inserts an advertisement content to a VoD content and reproduces the advertisement content with the VoD content;

FIG. 9 is a sequence diagram showing a method of inserting an advertisement content to an NRT-based Push VoD content and reproducing the advertisement content with the Push VoD content, according to an embodiment; and

FIG. 10 is a sequence diagram showing a method of inserting an advertisement content to an AV content and reproducing the advertisement content with the AV content by using a broadcasting company application.

### DETAILED DESCRIPTION OF THE EXEMPLARY EMBODIMENTS

Hereinafter, the aspects of the exemplary embodiments will be described in detail with reference to the attached drawings. In the description of the exemplary embodiments, certain detailed explanations of related art are omitted when it is deemed that they may unnecessarily obscure the essence of the aspects of the exemplary embodiments. Like reference numerals in the drawings denote like elements. For convenience of explanation, descriptions of a method and an apparatus will be given together if required.

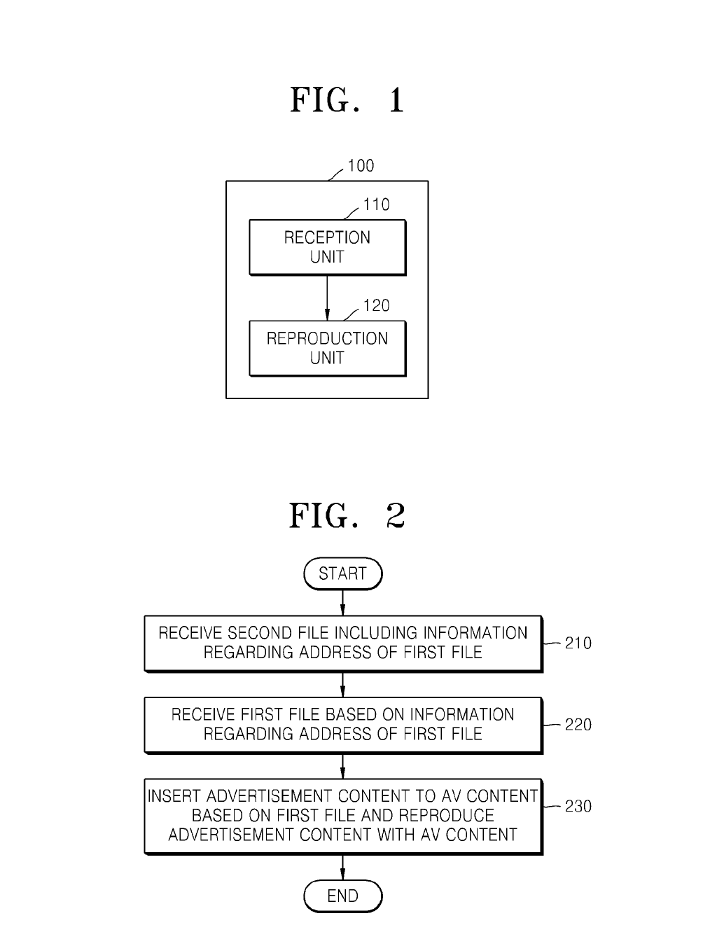

FIG. 1 is a diagram showing the configuration of an audio/video (AV) content receiver 100 for receiving AV content via a broadcasting network and an IP network, according to an exemplary embodiment. Referring to FIG. 1, the AV content receiver 100 includes a reception unit 110 and a reproduction unit 120.

FIG. 2 is a flowchart showing a method by which the AV content receiver 100 reproduces an advertisement. Referring to FIG. 2, the method by which the AV content receiver 100 reproduces an advertisement includes an operation in which the reception unit 110 receives a second file having information regarding address of a first file (operation 210), an operation in which the reception unit 110 receives the first file based on the information regarding address of the first file (operation 220), and an operation in which the reproduction unit 120 inserts advertisement content to an AV content based on the first file and reproduces the AV content (operation 230). Here, the advertisement content is inserted not only in the middle of the AV content, but also before or after the AV content.

The second file includes information required for reproduction of the AV content and information regarding address of the first file. According to an embodiment, the second file may be a content access descriptor (CAD) file.

According to an embodiment, information regarding address of the first file included in the second file may be included in an element ContentURL of a CAD file. According to another embodiment, information regarding address of the first file included in the second file may be included in an element of a CAD file that is newly defined for metadata of an advertisement content.

Address of the first file included in the second file may be an address for receiving the first file via an IP network or an address for receiving the first file via a broadcasting network. Address of the first file included in the second file may be a HTTP-type or a non real-time (NRT)-type address for receiving first file.

The first file includes metadata of an advertisement to be inserted into an AV content and reproduced. The first file may be a manifest file complying with the OHTV manifest schema. According to another embodiment, the first file may be an XML file that is newly defined for metadata of an advertisement content in compliance with the XML schema. According to another embodiment, the first file may be an media presentation description (MPD) file complying with the MPD schema of the 3GPP/IOPF.

The AV content receiver 100 may insert an advertisement content to a stream-based video on demand (VoD) content and reproduce the VoD content. In other words, the AV content receiver 100 may insert an advertisement content to an AV content streamed via an IP network and reproduce the AV content.

A streaming content having AS-CoD TransferType is a content to which adaptive streaming technique is applied, where a plurality of files with different bitrates may be combined and reproduced by using a manifest file.

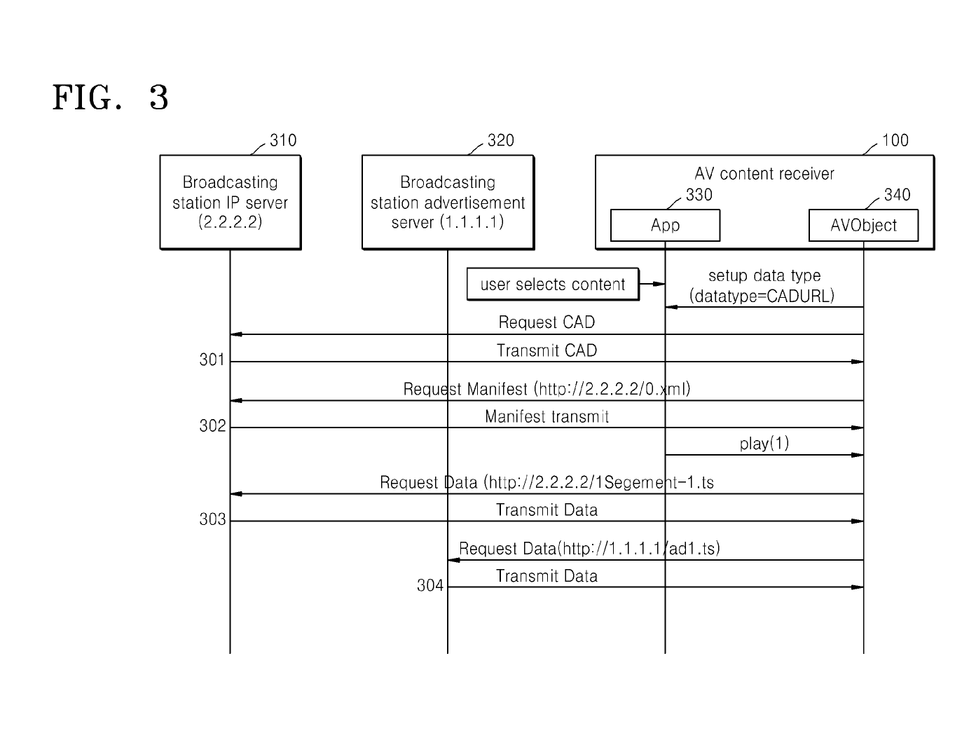

FIG. 3 is a sequence diagram showing a method of inserting an advertisement content to a stream-based VoD content and reproducing the VoD content, according to an embodiment. Referring to FIG. 3, when a user selects a content, an application 330 of the AV content receiver 100 transmits address of a CAD file to an AV object 340. After the AV object 340 receives the CAD file (operation 301), the AV object 340 receives a manifest file by referring to an address of the manifest file included in the CAD file, that is, http://2.2.2.2/0.xml (operation 302). The AV object 340 may include the reception unit 110 and the reproduction unit 120.

An example of manifest files according to embodiments is shown below:

```
    <AdaptiveControl>
    <NextAdaptiveControlURL>http://2.2.2.2/1.xml
<NextAdaptiveControlURL>
    <Track ID=“1” Type=“Packed” BitRate=“1000000”>
    <Segement StartTime=“00:00:00” Duration=“00:01:00” ID=“1”>
    <URL> http://2.2.2.2/1-segement1.ts </URL>
    </Segement>
    </Track>
    </AdaptiveControl>
    <AdaptiveControl>
    <Track ID=“2” Type=“Packed” BitRate=“1000000”>
    <Segement StartTime=“00:00:00” Duration=“00:01:00” ID=“1”>
    <URL> http://1.1.1.1/ad.ts </URL>
    </Segement>
    </Track>
    </AdaptiveControl>
```

Here, the element Segment indicates a portion of content divided on time basis.

Based on the manifest file, the AV content receiver 100 receives an AV content from an IP server 310 of a broadcasting station and reproduces the AV content (operation 303) and receives an advertisement content from a broadcasting station advertisement server 320 and reproduces the advertisement content with the AV content (operation 304). Reproduction of content in a broadcast receiver is well-known to one of ordinary skill in the related art, and thus detailed description thereof will be omitted.

The AV content receiver 100 may reproduce a local advertisement content stored in the AV content receiver 100. In this case, the first file may include information regarding identifier of the advertisement content stored in the AV content receiver 100.

According to an embodiment, the AV content receiver 100 may reproduce a local advertisement content by defining an attribute LocalContentID in the element Segment of the manifest schema. A value of the attribute LocalContentID may be a unique content ID complying with the Ubiquitous/Universal Content Identifier (UCI) standards. In a case where the manifest file includes the attribute LocalContentID, the AV content receiver 100 may reproduce stored advertisement content corresponding to the attribute LocalContentID if the advertisement content is stored in the AV content receiver or may receive the corresponding advertisement content from the advertisement server 320 and reproduce the received advertisement content if the advertisement content is not stored in the AV content receiver 100.

An example of the element Segment employing the attribute LocalContentID according to embodiments is shown below.

<Segement StartTime=“00:00:00” Duration=“00:01:00”
ID=“1”LocalContentID=“uci-kbs-1111”/>

As described above, according to an embodiment, a locally stored advertisement content may be inserted to a stream-based AV content and reproduced with the AV content.

The AV content receiver 100 may insert an advertisement content to a download-based VoD content and reproduce the advertisement content with the VoD content. In other words, the AV content receiver 100 may insert an advertisement content to an AV content downloaded via an IP network and stored in the AV content receiver 100 and reproduce the advertisement content with the AV content.

To receive a manifest file regarding a downloaded AV content, the downloaded AV content may have AS-Download TransferType. In an AV content having the AS-Download TransferType, address of a manifest file is included in a CAD file, and thus the AV content may be reproduced according to the manifest file downloaded from the address. Like an AV content having AS-Cod TransferType, a plurality of files may be combined and reproduced in an AV content having AS-Download TransferType. In other words, the AV content receiver 100 may connect a downloaded and stored file to at least one other file and reproduce the files continuously. An AV content having AS-Download TransferType may be downloaded by using an adaptive streaming technique.

Based on a manifest file, the AV content receiver 100 may insert an advertisement content file to a local AV content file and reproduce the advertisement content file with the AV content file. Here, the advertisement content file may not only be a local file stored in the AV content receiver 100, but also be a file stored in the advertisement server 320.

A downloaded AV content may have AS-PlayableDownload TransferType or AS-FullDownload TransferType. In a case of AS-PlayableDownload TransferType, the AV content receiver 100 may reproduce an AV content and an advertisement content while downloading the AV content. In a case of AS-FullDownload TransferType, the AV content receiver 100 may reproduce an AV content and an advertisement content after the AV content is completely downloaded.

The AV content receiver 100 may report information regarding advertisement viewing to a service provider. In this case, the first file may include information regarding an address for reporting a result of reproducing an advertisement content, and the AV content receiver 100 may report a result of reproducing the advertisement content by using the address included in the first file.

In a case where the element Segment of a manifest schema includes an attribute ReportingURL and the AV content receiver 100 accesses the element Segment, the AV content receiver 100 may access an address corresponding to a value of the attribute ReportingURL. At this point, the AV content receiver 100 may report a result of reproducing an advertisement content by using HTTP Get method and setting a value of HTTP Body to Null.

An example of the element Segment employing the attribute ReportingURL is shown below.

<SegementStartTime=“00:00:00”Duration=“00:01:00”ID=“1”
ReportingURL=http://1.1.1.1/report?=ad1/>

The AV content receiver 100 may control player control level to prevent a user from skipping an advertisement content. Here, the first file may include information regarding authorization for controlling reproduction of the advertisement content, and the AV content receiver 100 may determine a player control level allowed to a user based on the information.

According to an embodiment, authorization for controlling an advertisement content may be designated by providing an attribute ControlLevel to the element Segment of a manifest schema.

Examples of values of the attribute ControlLevel are shown below.

0: All Allowed (Default)

1: Skip Prohibited (Only Pause, Stop, and Resume are allowed)

2: All Controls Prohibited

An example of the element Segment employing the attribute ReportingURL is shown below.

<Segement StartTime=“00:00:00” Duration=“00:01:00” ID=“1”
ControlLevel=1 />

The AV content receiver 100 may insert an advertisement content to an NRT-based content, e.g., a Push VoD content, and reproduce the advertisement content with the NRT-based content. In other words, the AV content receiver 100 may insert an advertisement content to an AV content that is received via a broadcasting network and stored in the AV content receiver 100 and reproduce the advertisement content with the AV content.

The AV content receiver 100 may receive not only a file delivery table (FDT), but also a CAD file while an AV content is being downloaded in NRT method. The AV content receiver 100 may receive a manifest file based on address of the manifest file included in the received CAD file. Here, the address of the manifest file is an address from which a manifest file may be received via NRT method. Reproduction of an advertisement content in the NRT method is the same as the reproduction of an advertisement content with a streamed content or reproduction of an advertisement content with a downloaded content. The AV content receiver 100 may combine and reproduce a plurality of files according to a manifest file. In other words, the manifest file defines how to reproduce files in a current session.

The AV content receiver 100 may insert an advertisement content file to an NRT-based AV content file based on a manifest file and reproduce the advertisement content with the AV content, where the advertisement content may not only be a file stored in the AV content receiver 100, but also be a file stored in the advertisement server 320. An advertisement content stored in the AV content receiver 100 may be a file received via a broadcasting network or an IP network and stored.

An example of CAD files of Push VOD contents according to embodiments is shown below.

```
    <Contents>
    <ContentItem>
    <Title> title</Title>
    <Synopsis> synopsis</Synopsis>
    <OriginalSite>http://2.2.2.2</OriginalSite>
  <OriginalSiteName>sitename</OriginalSiteName>
    <ContentID>cid</ContentID>
    <ContentURLVideoCoding=“AVC” Duration=“1:00:00” Size=“size”
MediaFormat=“MP2TS”TransferType=“AS-
Download”>./Manfiest.xml</ContentURL>
    </ContentItem>
    <Contents>
```

Here, “./Manifest.xml” indicates a Content-Location address of FDT-Instance XML.

An example of manifest files of Push VOD contents according to embodiments is shown below.

<AdativeControl>
<Track ID=“1” Type=“Packed” BitRate=“1000000”>
<Segement StartTime=“00:00:00” Duration=“00:01:00” ID=“1”>
<URL> ./1-segement1.ts </URL>
</Segement>
<Segement StartTime=“00:01:00” Duration=“00:01:00” ID=“1”>
<URL> ./ad.ts </URL>
</Segement>
</Track>
</AdaptiveControl>

Here, “./1-segment1.ts” and “./ad.ts” indicate a Content-Location address of FDT-Instance XML.

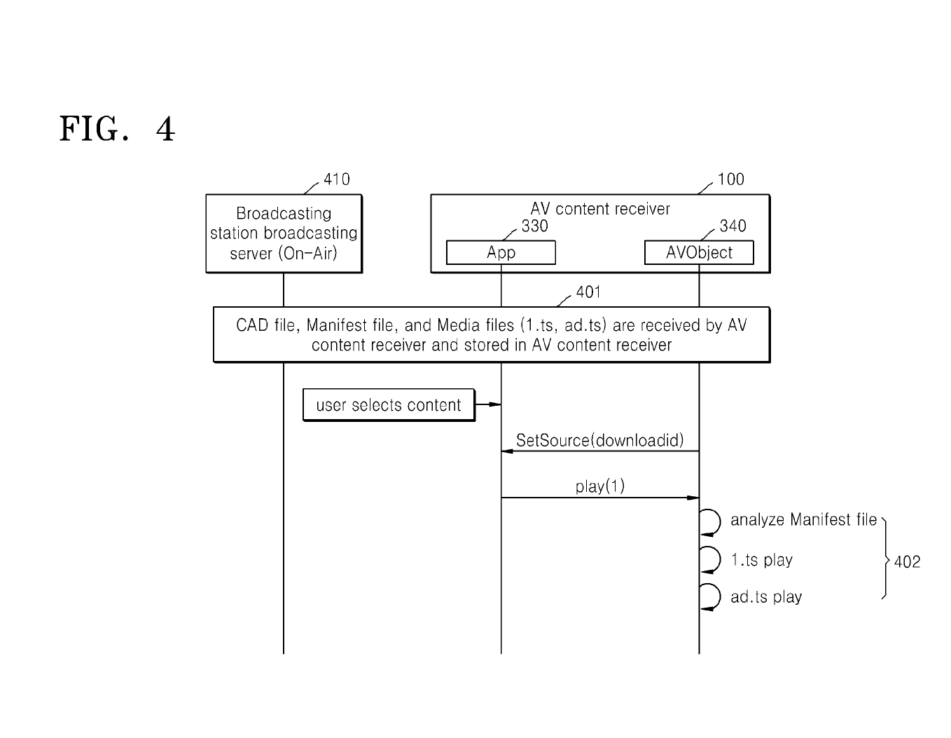

FIG. 4 is a sequence diagram showing a method of inserting an advertisement content to an NRT-based Push VoD content and reproducing the advertisement content with the Push VoD content, according to an embodiment. Referring to FIG. 4, CAD files, manifest files, and media files of AV contents are already received from a broadcasting server 410 of a broadcasting station and stored in the AV content receiver 100, according to the NRT method. The media file include one or more AV content files and one or more advertisement content files. In FIG. 4, a file 1.ts is an AV content, whereas a file ad.ts is an advertisement content. When a user selects an AV content, the AV object 340 inserts the advertisement content to the AV content according to a description included in a corresponding manifest file and reproduces the advertisement content with the AV content (operation 402).

The AV content receiver 100 may insert an advertisement content to an AV content and reproduce the advertisement content with the AV content by using a broadcasting company application.

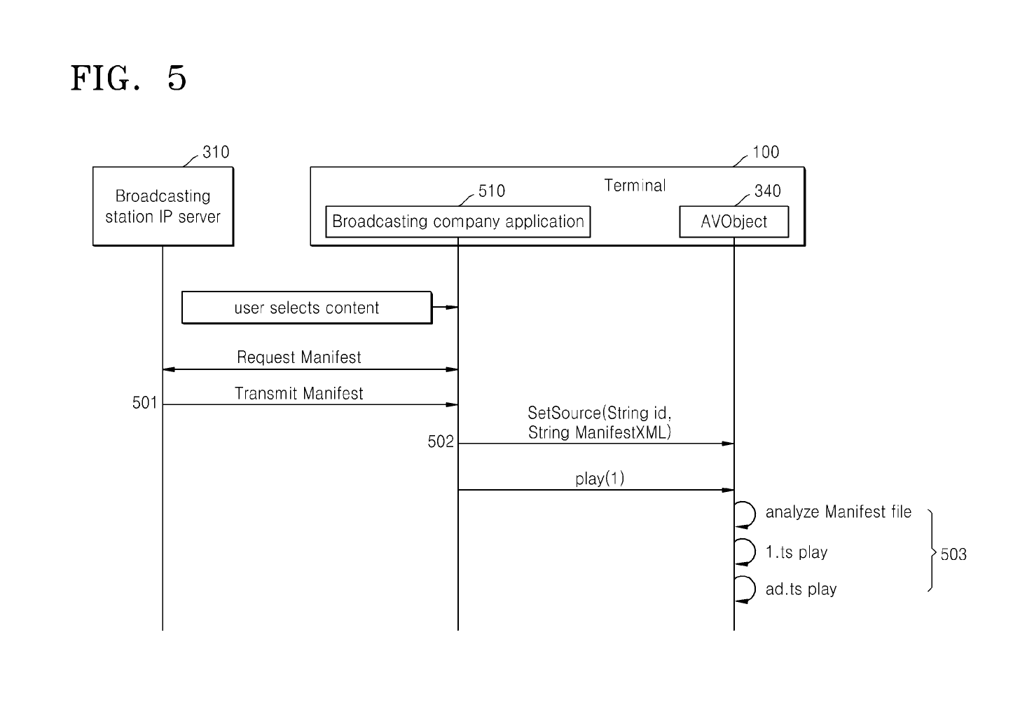

FIG. 5 is a sequence diagram showing a method of inserting an advertisement content to an AV content and reproducing the advertisement content with the AV content by using a broadcasting company application. Referring to FIG. 5, when a user selects an AV content, the broadcasting company application 510 of the AV content receiver 100 receives a corresponding manifest file from the IP server 310 (operation 501) and transmits metadata of an advertisement content included in the received manifest file to the AV object 340 (operation 502). The AV object 340 inserts the advertisement content to the AV content according to the transmitted metadata and reproduces the advertisement content with the AV content (operation 503). Here, the advertisement content file may not only be a local file stored in the AV content receiver 100, but may also be a file stored in the advertisement server 320. Therefore, according to embodiments, even in a case where the broadcasting company application 510 reproduces an AV content stored in the AV content receiver, the latest advertisement content may be inserted to the AV content and reproduce with the AV content. The advertisement content file stored in the AV content receiver 100 may be a file received via an IP network or a broadcasting network and stored.

An address from which a manifest file may be received may be included in the broadcasting company application 510. According to embodiments, the broadcasting company application 510 may not receive a manifest file from the IP server 310 and a manifest content may be integrated in the broadcasting company application 510.

According to an embodiment, for the broadcasting company application 510 to transmit metadata to the AV object 340, an API such as SetSource (String id, String ManifestXML) may be defined aside from SetSource (String id) of the AV object 340. Here, the ManifestXML is an XML string corresponding to a manifest file according to embodiments.

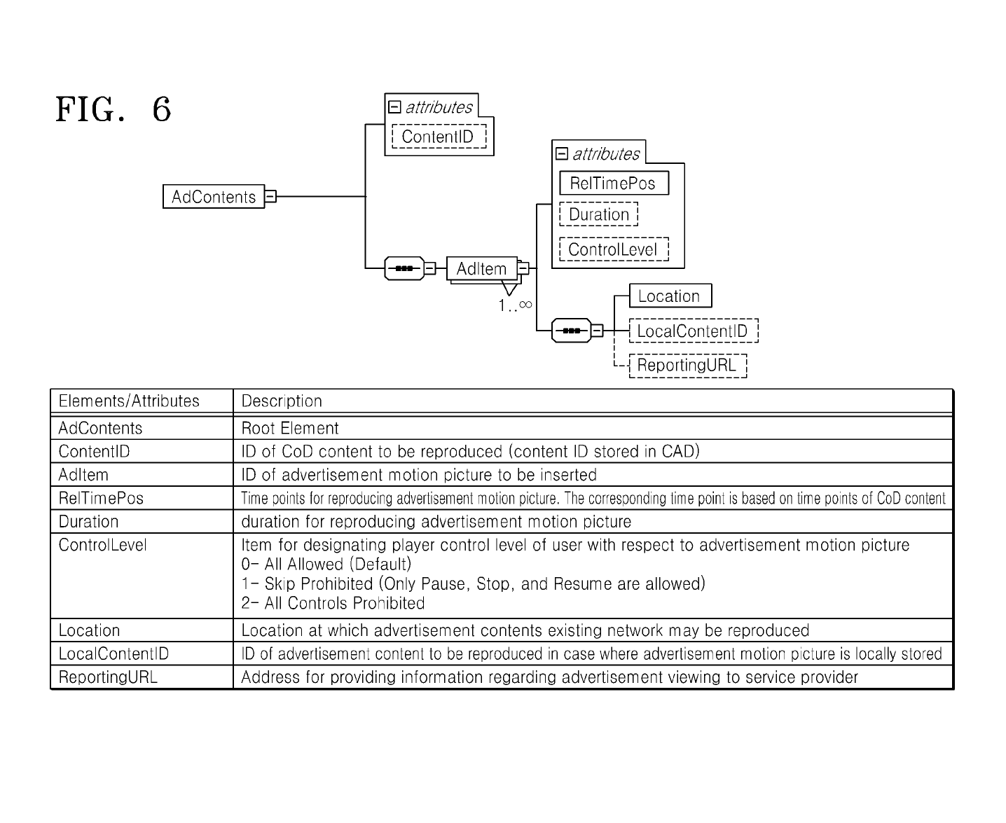

According to an embodiment, a new XML schema may be defined for metadata of an advertisement content. For example, AdContents XML schema may be defined, where Mime-Type thereof may be defined as application/x-ohtv-adcontents+xml. AdContents XML schema according to an embodiment is shown in FIG. 6.

An example of an advertisement content metadata XML file according to AdContents XML schema (referred to hereinafter as an AdContents XML file) is shown below.

```
    <?xml version=“1.0” encoding=“UTF-8”?>
    <AdContentsxmlns:xsi=“http://www.w3.org/2001/XMLSchema-
instance”>
      <AdItemRelTimePos=“00:00:00”Duration=“00:00:30”
ControlLevel=“1”>
      <Location>http://kbs.co.kr/adcontents/galaxys.avi</Location>
      <LocalContentID> uci-kbs-ad1 </LocalContentID>
      <ReportingURL>http://kbs.co.kr/adcontents/report?id=uci-kbs-
ad1</ReportingURL>
      </AdItem>
        <AdItemRelTimePos=“00:30:00”Duration=“00:00:30”Control
    Level=“2”>
        <Location>http://kbs.co.kr/adcontents/optimus.avi</Location>
        <LocalContentID> uci-kbs-ad2 </LocalContentID>
        <ReportingURL>http://kbs.co.kr/adcontents/report?id=uci-kbs-
    ad2</ReportingURL>
            </AdItem>
        </AdContents>
```

According to an embodiment, an advertisement content may be inserted to an AV content and reproduced with the AV content without changing a description in an existing CAD schema by defining an element AdContents of which value indicates an address for receiving an AdContents XML file. The URL format of an address of the element AdContents includes NRT and HTTP.

An example of CAD files for inserting an advertisement content to a stream-based VoD content by using the element AdContents and reproducing the advertisement content with the VoD content is shown below.

```
    <Contents>
    <ContentItem>
    <Title> title</Title>
    <Synopsis> synopsis</Synopsis>
    <OriginalSite>http://2.2.2.2</OriginalSite>
    <OriginalSiteName>sitename</OriginalSiteName>
    <ContentID>cid</ContentID>
    <ContentURL Video Coding=“AVC” Duration=“1:00:00”
    Size=“size”
MediaFormat=“MP2TS”
TransferType=“streaming”>http://kbs.co.kr/movies/1.ts</ContentURL>
    <AdContents>
    http://kbs.co.kr/adcontents/adcontent1.xml</AdContents>
    </ContentItem>
    <Contents>
```

The AV content receiver 100 may receive an AdContents XML file by using URL information of the element AdContents of a CAD file, reproduce an advertisement content in the advertisement server 320 by using elements AdContents/AdItem/Location of the AdContents XML file, and reproduce a locally stored advertisement content by using elements AdContents/AdItem/LocalContentID of the AdContents XML file.

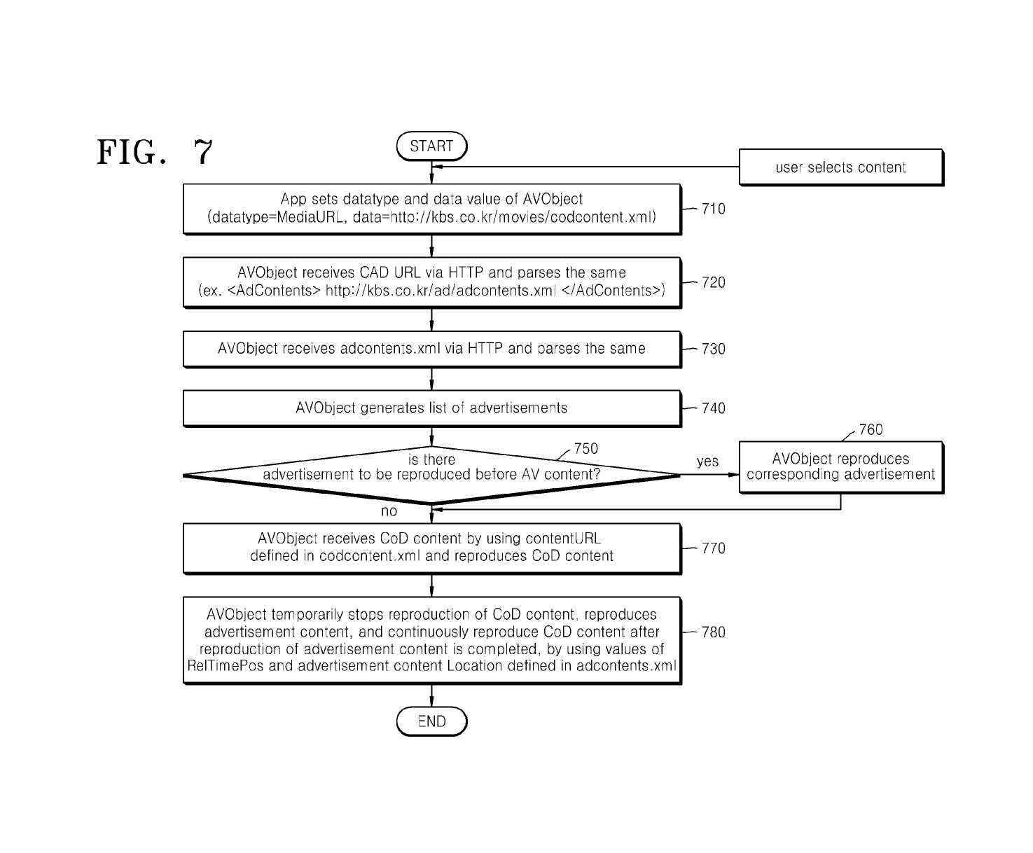

FIG. 7 is a flowchart showing a method by which the AV content receiver 100 according to an exemplary embodiment inserts an advertisement content to a VoD content and reproduces the advertisement content with the VoD content.

When a user selects a content, the application 330 sets up data type and data value of the AV object 340 (operation 710). The AV object 340 receives a CAD file, parses the CAD file, and extracts address of an AdContents XML file therefrom (operation 720). The AV object 340 receives the AdContents XML file, parses the AdContents XML file (operation 730), and generates a list of advertisements (operation 740). The AV object 340 determines whether there is an advertisement content to be reproduced before an AV content (operation 750), selectively reproduces the corresponding advertisement content based on a result of the determination (operation 760), and reproduces the AV content (operation 770). According to the AdContents XML file, the AV object 340 inserts and reproduces an advertisement content during or after reproduction of the AV content (operation 780). Reproductions of the AV content and the advertisement content are terminated after the AV content and the advertisement contents are completely reproduced or according to a request of the user.

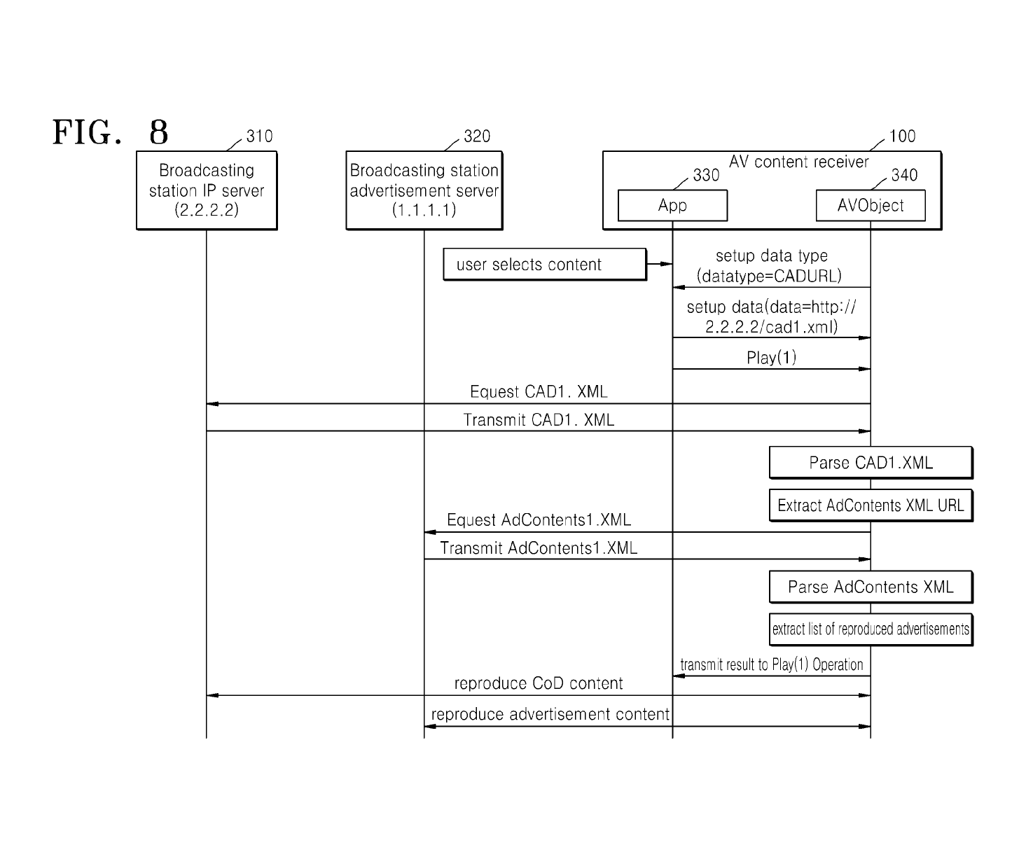

FIG. 8 is a sequence diagram showing a method by which the AV content receiver 100 according to exemplary embodiment inserts an advertisement content to a VoD content and reproduces the advertisement content with the VoD content. The method shown in FIG. 8 is substantially identical to the method shown in FIG. 7, and thus detailed description thereof will be omitted.

An example of CAD files for inserting an advertisement content to a download-based VoD content by using the element AdContents and reproducing the advertisement content with the VoD content is shown below.

```
    <Contents>
    <ContentItem>
    <Title> title</Title>
    <Synopsis> synopsis</Synopsis>
    <OriginalSite>http://2.2.2.2</OriginalSite>
    <OriginalSiteName>sitename</OriginalSiteName>
    <ContentID>cid</ContentID>
    <ContentURL VideoCoding=“AVC” Duration=“1:00:00” Size=“size”
MediaFormat=“MP2TS”
TransferType=“full_download”>http://kbs.co.kr/movies/1.ts
</ContentURL>
    <AdContents>
http://kbs.co.kr/adcontents/adcontent1.xml</AdContents>
    </ContentItem>
    <Contents>
```

In a case where TransferType is full download, a received AdContents XML may be stored and an advertisement content may be reproduced by using the corresponding AdContents XML during later reproduction of an AV content. In a case where TransferType is playable download, a received AdContents XML may be stored and an advertisement content may be reproduced at a corresponding time points. If a user requests reproduction of the advertisement content after the AV content is completely stored, the advertisement content may be reproduced again by using the stored AdContents XML.

The AV content receiver 100 may report a result of reproducing an advertisement content by using the elements AdContents/AdItem/ReportingURL of an AdContents XML file. At this point, the AV content receiver 100 may report a result of reproducing an advertisement content by using HTTP Get method and setting a value of HTTP Body to Null.

The AV content receiver 100 may control player control level of a user by using attributes AdContents/AdItem/ControlLevel of an AdContents XML file. Examples of values of the attribute ControlLevel according to embodiments are shown below.

0: All Allowed (Default)
1: Skip Prohibited (Only Pause, Stop, and Resume are allowed)
2: All Controls Prohibited

In a case of receiving an NRT-based Push VoD content, the AV content receiver 100 may receive a CAD file including the element AdContents having an address for receiving an AdContents XML file, receive the AdContents XML file by using URL information of the element AdContents of the CAD file, insert an advertisement content to the Push VoD content by using the AdContents XML file, and reproduce the advertisement content with the Push VoD content. Reproduction of an advertisement content in NRT method is same as reproduction of advertisement content with a streamed content or reproduction of advertisement content with a downloaded content.

An example of inserting an advertisement content to a Push VoD content by using the element AdContents and reproducing the advertisement content with the Push VoD content is shown below.

```
    <Contents>
    <ContentItem>
    <Title> title</Title>
    <Synopsis> synopsis</Synopsis>
    <OriginalSite>http://2.2.2.2</OriginalSite>
    <OriginalSiteName>sitename</OriginalSiteName>
    <ContentID>cid</ContentID>
    <ContentURL VideoCoding=“AVC” Duration=“1:00:00” Size=“size”
MediaFormat=“MP2TS” TransferType=“full_download”>./movie/cod.ts
</ContentURL>
    <AdContents> ./movie/cod-adcontent.xml</AdContents>
    </ContentItem>
    <Contents>
```

Here, “./movie/cod.ts” and “./movie/cod-adcontent.xml” indicate a Content-Location address of FDT-Instance XML.

An example of AdContents XML files of Push VOD contents is shown below.

```
    <?xml version=“1.0” encoding=“UTF-8”?>
    <AdContents xmlns:xsi=“http://www.w3.org/2001/XMLSchema-
instance”>
        <AdItem RelTimePos=“00:00:00” Duration=“00:00:30”
ControlLevel=“1”>
          <Location>./movie/ad1.ts </Location>
          <LocalContentID> uci-kbs-ad1 </LocalContentID>
          <ReportingURL>http://kbs.co.kr/adcontents/report?id=uci-
    kbs-ad1</ReportingURL>
        </AdItem>
        <AdItem RelTimePos=“00:30:00” Duration=“00:00:30”
    ControlLevel=“2”>
          <Location>./movie/ad2.ts</Location>
          <LocalContentID> uci-kbs-ad2 </LocalContentID>
          <ReportingURL>http://kbs.co.kr/adcontents/report?id=uci-
    kbs-ad2</ReportingURL>
        </AdItem>
        </AdContents>
```

Here, “./movie/ad1.ts” and “./movie/ad2.ts” indicate a Content-Location address of FDT-Instance XML.

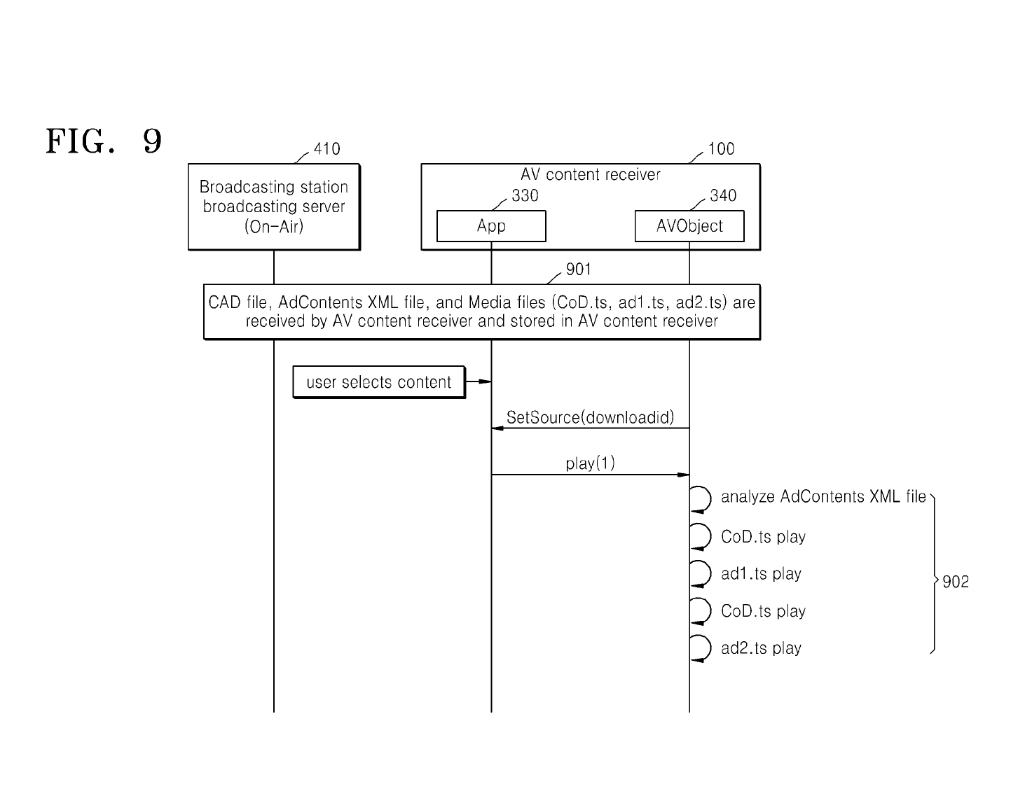

FIG. 9 is a sequence diagram showing a method of inserting an advertisement content to an NRT-based Push VoD content and reproducing the advertisement content with the Push VoD content, according to an embodiment. Referring to FIG. 9, CAD files, AdContents XML files, and media files of AV contents are already received from a broadcasting server 410 of a broadcasting station and stored in the AV content receiver 100, according to NRT method (operation 901). The media files include one or more AV content files and one or more advertisement content files. In FIG. 9, a file CoD.ts is an AV content, whereas a file ad1.ts and ad2.tx are advertisement contents. In CAD, all of received files are defined as a single content. When a user selects an AV content, the AV object 340 inserts the advertisement contents to the AV content according to a description included in a corresponding AdContents XML file and reproduces the advertisement contents with the AV content (operation 902).

The AV content receiver 100 according to the present embodiment may insert an advertisement content to an AV content and reproduce the advertisement content with the AV content by using a broadcasting company application according to AdContents XML schema.

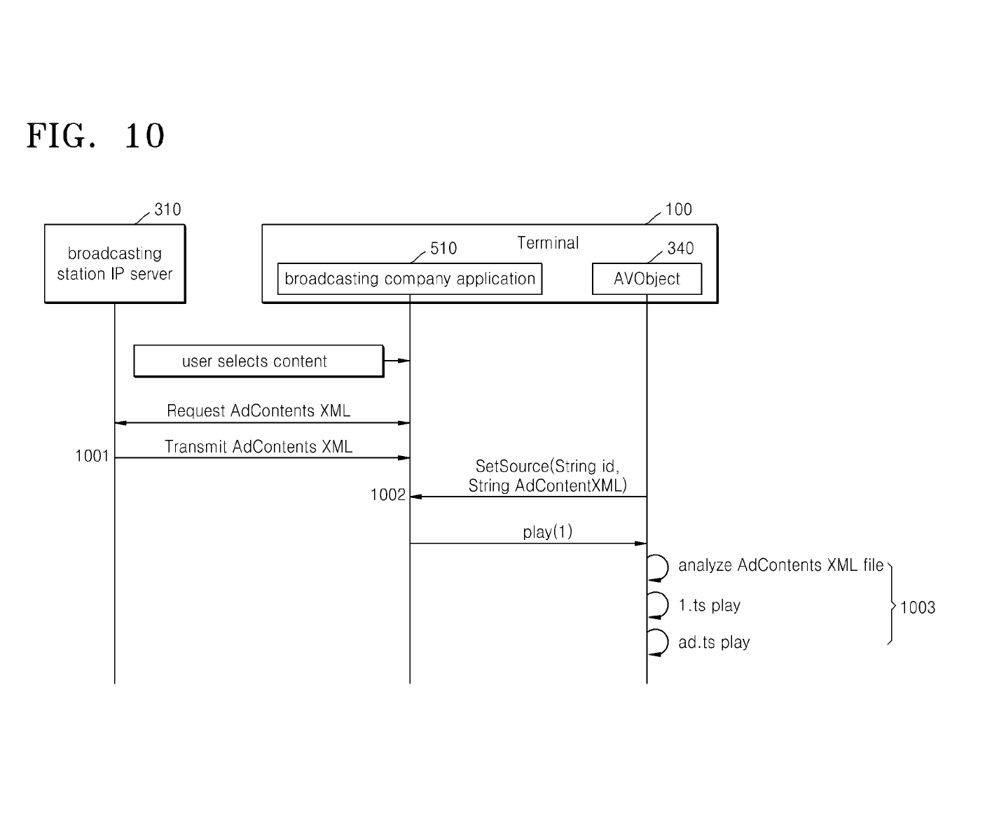

FIG. 10 is a sequence diagram showing a method of inserting an advertisement content to an AV content and reproducing the advertisement content with the AV content by using a broadcasting company application. Referring to FIG. 10, when a user selects an AV content, the broadcasting company application 510 of the AV content receiver 100 receives a corresponding AdContents XML file from the IP server 310 (operation 1001) and transmits metadata of an advertisement content included in the received AdContents XML file to the AV object 340 (operation 1002). The AV object 340 inserts the advertisement content to the AV content according to the transmitted metadata and reproduces the advertisement content with the AV content (operation 1003). Here, the advertisement content file may not only be a local file stored in the AV content receiver 100, but also be a file stored in the advertisement server 320. Therefore, even in a case where the broadcasting company application 510 reproduces an AV content stored in the AV content receiver, the latest advertisement content may be inserted to the AV content and reproduce with the AV content.

According to embodiments, the broadcasting company application 510 may not receive a AdContents XML file from the IP server 310 and a AdContents XML content may be integrated in the broadcasting company application 510.

For the broadcasting company application 510 to transmit metadata to the AV object 340, an API such as SetSource (String id, String AdContents XML) may be defined aside from SetSource (String id) of the AV object 340. Here, the AdContents XML is a text string complying with AdContents XML schema.

According to an embodiment, for metadata of an advertisement content, an extension of MPD of 3GPP/OIPF may be used. According to an embodiment, to report a result of reproducing an advertisement content, the AV content receiver 100 may state a reporting address in an element MPD, an element Representation, or an element SegmentInfo of 3GPP/OIPF.

An example of stating a reporting address URL in the element SegmentInfo is shown below.

<SegmentInfo ReportingURL=“http://2.2.2.2/report”>

The AV content receiver 100 may define a player control level in the element MPD, the element Representation, or the element SegmentInfo of 3GPP/OIPF to control a player control level allowed to a user.

An example of stating a player control level in the element SegmentInfo is shown below.

<SegementInfo ControlLevel=“1”>

To reproduce an advertisement content stored in the AV content receiver 100, the AV content receiver 100 may define information for identifying a local advertisement content, such as content IDs or content categories, in the element MPD, the element Representation, or the element SegmentInfo of 3GPP/OIPF to control a player control level allowed to a user.

An example of stating a content ID in the element SegmentInfo is shown below.

<SegementInfo ContentID=“1111”>

During reproduction of an AV content using NRT, MPD may be received by using NRT and be used for reproducing an advertisement content.

Although detailed descriptions of defining advertisement content metadata in manifest schema, AdContents schema, and MPD schema are given above, advertisement content metadata may be stated in various forms as elements or attributes in the highest level content, track, or Segment descriptions.

The exemplary embodiments can also be embodied as computer readable codes on a non-transitory computer readable recording medium. The non-transitory computer readable recording medium is any data storage device that can store data which can be thereafter read by a computer system. Examples of the non-transitory computer readable recording medium include read-only memory (ROM), random-access memory (RAM), CD-ROMs, magnetic tapes, floppy disks, optical data storage devices, etc. The non-transitory computer readable recording medium can also be distributed over network coupled computer systems so that the computer readable code is stored and executed in a distributed fashion. Also, functional programs, codes, and code segments for accomplishing the aspects of the exemplary embodiments can be easily construed by programmers skilled in the art to which the present inventive concept pertains.

While the aspects of the inventive concept have been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A method of reproducing an advertisement in an audio/video (AV) content receiver which receives AV content via a broadcasting network and an Internet Protocol (IP) network, the method comprising:
receiving a second file comprising information regarding an address of a first file which includes information required for reproducing the AV content and metadata of the advertisement content to be inserted into the AV content and reproduced with the AV content;
receiving the first file based on the information regarding the address of the first file; and
inserting the advertisement content to the AV content based on the metadata of the advertisement content comprised in the first file and reproducing the advertisement content with the AV content.

2. The method of claim 1, wherein the address of the first file is an address for receiving the first file via the IP network or an address for receiving the first file via the broadcasting network.

3. The method of claim 1, wherein the second file is a content access descriptor (CAD) file of the AV content.

4. The method of claim 1, wherein the first file is an open hybrid TV (OHTV) manifest file.

5. The method of claim 1, wherein the first file further comprises information regarding an identifier of the advertisement content stored in the AV content receiver.

6. The method of claim 5, wherein the AV content comprises at least a portion divided on time basis,
the information regarding the identifier of the advertisement content included in the first file is included in a value of an attribute of a same level element as an element comprising at least the portion divided on time basis.

7. The method of claim 1, wherein the first file further comprises information regarding an address for reporting a result of reproducing the advertisement content.

8. The method of claim 7, wherein the AV content comprises at least a portion divided on time basis,
the information regarding the address for reporting the result of reproducing the advertisement content included in the first file is included in a value of an attribute of a same level element as an element comprising at least the portion divided on the time basis.

9. The method of claim 1, wherein the first file further comprises information regarding player control level for controlling reproduction of the advertisement content.

10. The method of claim 1, wherein the information regarding address of the first file included in the second file is included in an element arranged separately from an element comprising information required for reproducing the AV content.

11. The method of claim 10, wherein the first file comprises at least one of:
an element comprising information regarding a location of the advertisement content in a server;
an element comprising information regarding an identifier of the advertisement content stored in the AV content receiver;
an element comprising information regarding an address for reporting a result of reproducing the advertisement content; and
an element comprising information regarding authorization for controlling reproduction of the advertisement content.

12. The method of claim 1, wherein the first file is a media presentation description (MPD) of 3GPP/OIPF.

13. The method of claim 1, wherein the AV content is streamed via the IP network, and
the advertisement content is stored in the AV content receiver.

14. The method of claim 1, wherein the AV content is downloaded via the IP network and stored in the AV content receiver.

15. The method of claim 14, wherein an element TransferType of the AV content indicates that reproduction of the AV content is a combined reproduction of a file downloaded via the IP network and stored in the AV content receiver with at least one other files.

16. The method of claim 1, wherein the AV content is received via the broadcasting network and stored in the AV content receiver.

17. The method of claim 16, wherein the AV content is received by using non real-time (NRT) method, and
the second file is a CAD file of an AV content received by using NRT method.

18. The method of claim 16, wherein the first file further comprises information for combining and reproducing a plurality of files that are received via the broadcasting network and stored in the AV content receiver.

19. A method of reproducing an advertisement in an Audio/Video (AV) content receiver which receives AV content via a broadcasting network and an Internet Protocol (IP) network, the method comprising:
providing through a broadcasting company application an identifier of an AV content and metadata of the advertisement content to be inserted to the AV content and reproduced with the AV content to an AV object; and
inserting using the AV object the advertisement content into the AV content based on the identifier of the AV content and the metadata of the advertisement content and reproducing the advertisement content with the AV content.

20. The method of claim 19, wherein the metadata of the advertisement content comprises an address for receiving the advertisement content via the IP network or an address for receiving the advertisement content via the broadcasting network.

21. The method of claim 19, wherein the metadata of the advertisement content is an Extensible Markup Language (XML) string.

22. The method of claim 19, further comprising the broadcasting company application receiving the metadata of the advertisement content from a broadcasting company server.

23. An Audio/Video (AV) content receiver which receives AV contents via a broadcasting network and an Internet Protocol (IP) network, the AV content receiver comprising:
a reception unit which receives a second file including information regarding an address of a first file, which includes information required for reproducing an AV content and metadata of an advertisement content to be inserted to the AV content and reproduced with the AV content, and receives the first file based on the information regarding the address of the first file; and
a reproduction unit which inserts the advertisement content into the AV content based on the metadata of the advertisement content included in the first file and reproduces the advertisement content with the AV content.

24. The AV content receiver of claim 23, wherein the first file comprises information regarding an address for reporting a result of reproducing the advertisement content.

25. The AV content receiver of claim 23, wherein the first file comprises information regarding player control level for controlling reproduction of the advertisement content.

26. The AV content receiver of claim 23, wherein the AV content is streamed via the IP network, and
the advertisement content is stored in the AV content receiver.

27. The AV content receiver of claim 23, wherein the AV content is downloaded via the IP network and stored in the AV content receiver.

28. The AV content receiver of claim 23, wherein the AV content is received via the broadcasting network and stored in the AV content receiver.

29. An Audio/Video (AV) content receiver which receives AV contents via a broadcasting network and an IP network, the AV content receiver comprising:
a broadcasting company application unit which provides an identifier of an AV content and metadata of an advertisement content to be inserted to the AV content and reproduced with the AV content to an AV object; and
the AV object unit which inserts the advertisement content to the AV content based on the identifier of the AV content and the metadata of the advertisement content and reproduces the advertisement content with the AV content.

30. A non-transitory computer readable recording medium having recorded thereon a computer program for implementing the method of claim 1.

31. A non-transitory computer readable recording medium having recorded thereon a computer program for implementing the method of claim 19.

32. A method of reproducing an advertisement in an audio/video (AV) content receiver which receives AV content via a broadcasting network and an Internet Protocol (IP) network, the method comprising:
receiving a second file comprising information for reproducing the AV content and information regarding an address of a first file, the first file comprising metadata of an advertisement content to be added to the AV content and reproduced with the AV content;
receiving the first file based on the received second file; and
adding the advertisement content to the AV content based on the metadata of the advertisement content comprised in the first file and reproducing the advertisement content with the AV content.

33. The method of claim 32, wherein the advertisement content is added before the AV content, after the AV content or into the AV content.

34. The method of claim 32, wherein the advertisement content is added to a stream-based video on demand (VoD) content and reproduced.

35. The method of claim 32, wherein the advertisement content is stored in the AV content receiver.
